(19) United States
(12) Patent Application Publication
(10) Pub. No.: US 2024/0010845 A1
(43) Pub. Date: Jan. 11, 2024

(54) ACOUSTICAL BONDING OF EFFECT PIGMENTS

(71) Applicant: PPG Industries Ohio, Inc., Cleveland, OH (US)

(72) Inventors: Vijesh Anant Tanna, Pittsburgh, PA (US); Brian Edward Woodworth, Glenshaw, PA (US); Kristin Marie Bartlett, Lakewood, OH (US)

(73) Assignee: PPG Industries Ohio, Inc., Cleveland, OH (US)

(21) Appl. No.: 18/246,191

(22) PCT Filed: Sep. 23, 2021
(86) PCT No.: PCT/US2021/051796

§ 371 Date: Mar. 22, 2023

Related U.S. Application Data
(60) Provisional application No. 63/082,544, filed on Sep. 24, 2020.

(51) Int. Cl. C09D 5/03; C09D 7/80; C09D 7/62; C09D 175/06; B22F 1/102; B22F 1/142

(52) U.S. Cl. CPC C09D 5/035; C09D 5/032; C09D 7/80; C09D 7/62; C09D 175/06; B22F 1/102; B22F 1/142; B22F 2998/10; B22F 2999/00; B22F 2301/35; B22F 2301/052; B22F 2302/256; B22F 2302/45

(57) ABSTRACT

A method for producing a powder coating that can include receiving effect pigment particles and powder coating particles, mixing the effect pigment particles with the powder coating particles where the mixing includes imparts acoustic energy to the effect pigment particles and the powder coating particles, heating the effect pigment particles and the powder coating particles where the heating bonds the effect pigment particles to the powder coating particles, and cooling the bonded effect pigment particles and the powder coating particles.

### CROSS-REFERENCE TO RELATED APPLICATION

This application claims priority to U.S. Provisional Patent Application Ser. No. 63/082,544, filed Sep. 24, 2020, which is herein incorporated by reference in its entirety.

### FIELD OF THE INVENTION

The present invention relates to methods for adhering effect pigments to powder particles of the type used to form powder coatings, and methods for producing bonded powder coating particles using acoustical mixing.

### BACKGROUND OF THE INVENTION

Powder coatings used to provide an effect, such as a metallic-like appearance in architectural, automotive, aerospace, industrial coatings and the like typically include polymeric base powder particles to which metallic flakes or effect pigments are added to create such an effect.

One method for achieving this is through blending the effect pigment with the base powder particles; however, this process can result with a powder coating which has inconsistent application properties, and the overspray cannot be effectively reclaimed. Other methods include adding the effect pigment prior to an extrusion or blending with a contact blade to mix the effect pigment with the base powder particles and then adding heat to bond or adhere the effect pigments to the powder particles needed to produce a coating. These methods, however, can fracture, shear, tear and/or warp the pigments thereby reducing their effect or metallic appearance, performance (including durability) and/or quality. If the pigments are so damaged or distorted during the processing, the final coating may have an inconsistent or unacceptable appearance or performance.

More effective means of bonding effect pigments are being sought to improve homogeneity, application, performance and appearance of effect powder coatings.

### SUMMARY OF THE INVENTION

In a first embodiment of the present disclosure, a method for producing a powder coating mixture is provided. The method can include receiving effect pigment particles and powder coating particles, mixing the effect pigment particles with the powder coating particles where the mixing can include imparting acoustic energy to the effect pigment particles and the powder coating particles, heating the effect pigment particles and the powder coating particles where the heating bonds the effect pigment particles to the powder coating particles, and cooling the bonded effect pigment particles and the powder coating particles.

In a second embodiment of the present disclosure, a powder coating composition is provided. The composition may include a thermosetting polymeric binder and metallic effect pigment particles, where the thermosetting polymeric binder and metallic effect pigment particles are mixed with acoustic energy and heated to a transition temperature. In this case, the mixing and heating may bond the thermosetting polymeric binder to the metallic effect pigment particles

In another embodiment of the present disclosure, a method for producing a powder coating mixture is provided. The method can include receiving metallic effect pigment particles and powder particles where the powder particles include a thermosetting polymeric binder. The method can also include mixing the metallic effect pigment particles with the powder coating particle where the mixing includes imparting acoustic energy to the effect pigment particles and the powder coating particles where the acoustic energy heats the metallic effect pigment particles and the powder coating particles by a frictional interaction between the metallic effect pigment particles and the powder coating particles. The method can also include heating the metallic effect pigment particles and the powder coating particles to a transition temperature where the transition temperature is at or near a transitional temperature of the thermosetting polymeric binder. The method can also include bonding the metallic effect pigment particles to at least the thermosetting polymeric binder during the heating. The method can also include cooling the bonded metallic effect pigment particles and powder particles to form a powder particle mixture.

### BRIEF DESCRIPTION OF THE DRAWINGS

FIGS. 1A and 1B are microscopic images of powder coatings according to the examples described herein.

### DETAILED DESCRIPTION

The present application provides formulations of, and methods for making, powder coating mixtures that include effect pigment particles. In this case, the components of the powder coating mixture may be mixed by acoustical energy. The acoustical energy may cause for frictional interactions between the effect pigment particles and one or more powder coating components, the frictional interactions heating the powder coating mixture during acoustical mixing until a temperature at (or near) a transitional temperature of the powder coating components is reached. In some cases, additional heat may be supplied to heat the mixture to the transitional temperature and/or cooling may be supplied to hold the temperature at or near the transitional temperature. In either case, the effect pigment particles bond to the bonding agent once bonding agent becomes tacky (e.g., the bonding agent becoming tacky when held at or near the transitional temperature for a resonance time). The bonded powder coating mixture may then be cooled and applied (e.g., via spraying) to a variety of different substrates.

In this case, acoustical mixing may provide certain benefits over other mixing techniques, such as preserving the integrity of the effect pigment particles during mixing, as well as enabling thorough dispersion of the effect pigment particles throughout the powder coating mixture. In these cases certain powder coating performance benefits may be observed, such as high effect pigment performance (e.g., high glitter, sparkle, etc.) and flexibility in industrial applications (e.g., consistent powder coating performance over a variety of spray conditions).

### I. Definitions

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polymer, “a” pigment, and the like refer to one or more of any of these items.

### II. Effect Pigments

It is often desirable to incorporate effect pigment particles, such as metallic flakes and/or mineral flakes, into powder coating compositions whereas the appearance of coating changes based on the angle of observation. For example, the coating may appear as reflective and/or metallic and have a sparkle finish based upon how the coating is viewed. Incorporation of such effect pigment particles, however, into powder coating compositions can be difficult. These particles can be either extruded with the other components of the powder coating or post-added to a coating after extrusion. Passing the effect particles through an extruder, however, can result in a loss of appearance or other characteristics and can alter the size and/or shape of the particles. For example, if metallic flake is extruded with the other components of a powder coating composition and subsequently ground, the flake will become distorted or partially destroyed which can result in the loss of at least some of its luster. Post-addition of metallic flakes can also cause problems, particularly when applying the powder coating by electrostatic spray; these particles can pick up and/or hold a charge differently than the other coating components, which can cause a non-uniform effect upon electrostatic deposition, thus potentially causing for a non-uniform appearance of the coatings and/or diminishing the re-claim advantages of powder coatings.

A known approach to addressing the problems described above is to bond metallic flakes to resin particles in a powder coating composition by placing the flakes and the resin particles in a high intensity-high shear mixer, such as a Henschel Mixer®, Welex® mixer, Bepex® mixer, or Mixaco mixer, and spinning the mixture at a high speed until the resin particles become sufficiently soft to bond to or at least associate with the metallic flake particles. Unfortunately, this high intensity-high shear mixing process can not only break and/or reduce the size of the metallic flake but can displace the protective coating that is often included thereon, potentially leading to oxidation, orientation, and/or reproducibility problems.

The present disclosure therefore provides powder coating compositions that include effect pigment particles that are adhered to powder coating particles, wherein the effect pigment particles are either minimally or substantially not degraded. It would also be desirable to provide methods for making such powder coating compositions.

The present invention is directed to a method for bonding effect pigments to powder coating particles. As used herein, the term “effect pigment” or “effect pigments” means materials that exhibit a desired color or appearance, such as a solid, metallic, pearlescent, gloss, distinctness, gonioapparent effect or the like. Effect pigments may be used to produce coatings having flake appearances such as texture, sparkle, glint, coarseness and glitter as well as the enhancement of depth perception in the coatings imparted by the flakes.

Effect pigments include, but are not limited to, light absorbing pigments, light scattering pigments, light interference pigments, light reflecting pigments, fluorescent or phosphorescent pigments, thermochromic pigment, photochromic pigment, and gonioapparent pigments. Metallic particles or flakes can be examples of such effect pigments. They can be particles or flakes with specific or mixed shapes and dimensions. The term “gonioapparent flakes,” “gonioapparent pigment” or “gonioapparent pigments” refers to flakes, pigment or pigments that change color or appearance, or a combination thereof with a change in illumination angle or viewing angle. Metallic flakes, such as aluminum flakes, are examples of gonioapparent pigments. Interference pigments or pearlescent pigments can be further examples of gonioapparent pigments.

As used herein, reference to “effect” pigments is intended to include “metallic” pigments. Examples of metallic pigments include mica (including coated, natural and synthetic mica), metal oxide (such as aluminum, bronze, copper and gold), and glass (such as borosilicate glass, barium titanate glass particles, soda lime glass particles, and metal oxide coated glass). Commercially available pigments include for example those referred to as Xirallic®, Dynacolor®, Mearlin®, Luxan®, Sunmica® and the like pigments.

Suitable effect compositions that may be used in the coating compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional effect compositions can provide other perceptible properties, such as opacity or texture. In a non-limiting embodiment, effect compositions can produce a color shift, such that the color of the coating changes when the coating is viewed at different angles. Example color effect compositions are identified in U.S. Pat. No. 6,894,086, incorporated herein by reference.

Additional color effect compositions may include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

Any effect pigment vulnerable to damage in an extruder or mechanical bonding process may benefit from the present mixing method. The effect pigment particles in the powder coating compositions of the present invention may comprise particles that could and would be bent, deformed, oxidized and/or damaged when processed (i) in an extruder or similar apparatus, or (ii) in a high intensity-high shear mixer, such as those listed earlier, and mixed at a high speed. The effect pigments can include those having a high aspect ratio.

The effect pigment particles can have diameters (e.g., a d50 value) of about 1 micron or greater, about 2 microns or greater, about 5 microns or greater, about 10 microns or greater, about 20 microns or less, about 30 microns or less, about 40 microns or less, about 50 microns or less, 60 microns or less, or any range or value encompassed by these endpoints.

The aspect ratio of the effect pigment particles can be at least 5:1, such as 10:1 or greater, 20:1 or greater, 50:1 or greater, 100:1 or greater, 200:1 or greater, 500:1 or greater, 1000:1 or greater, 2000:1 or greater, 5000:1 or greater, or 10,000:1 or greater.

As previously indicated, in certain embodiments of the powder coating compositions of the present invention, the effect pigment particles are not substantially degraded or only minimally degraded. As used herein, when it is stated that the effect pigment particles are not “substantially degraded” it means that the properties of the particles have not been substantially affected as a result of the process by which the effect pigment particles have been adhered to the powder coating particles. For example, as indicated earlier, those skilled in the art will appreciate that certain methods of adhering effect pigment particles to powder coating particles in a powder coating composition, such as those described above that involve the use of physical stress, including those that employ a high intensity-high shear mixer, such as those listed earlier, can and will deform and/or fragment the effect pigment particle, thus degrading the properties of the particle.

In some cases, effect pigment particles may be coated with a dispersant. A dispersant may be used to assist in the adhesion of the effect pigment particles to one or more components of the powder coating mixture. Examples of such dispersants include, without limitation, aromatic carboxylic acid such as benzoic acid, vinyl benzoate, salicylic acid, anthranilic acid, m-aminobenzoic acid, p-aminobenzoic acid, 3-amino-4-methylbenzoic acid, 3,4-diaminobenzoic acid, p-aminosalicylic acid, 1-naphthoic acid, 2-naphthoic acid, naphthenic acid, 3-amino-2-naphthoic acid, cinnamic acid, and aminocinnamic acid; amino compound such as ethylenediamine, trimethylenediamine, tetramethylenediamine, pentamethylenediamine, hexamethylenediamine, 1,7-diaminoheptane, 1,8-diaminooctane, 1,10-diaminodecane, 1,12-diaminododecane, o-phenylenediamine, m-phenylenediamine, p-phenylenediamine, 1,8-diaminonaphthalene, 1,2-diaminocyclohexane, stearylpropylenediamine, N-β-(aminoethyl)-γ-aminopropyltrimethoxysilane, and N-β-(aminoethyl)-γ-amino-propylmethyldimethoxysilane; and aluminum or titanium chelate compound.

### III. Powder Coating Particles

The present invention includes powder coating particles. Effect pigments can range in size and type. Typical sizes are between 10-50 micrometers. The effect pigments can be encapsulated in coatings such as a silica or polymer layer to provide enhanced protection.

Further the present invention includes a powder coating particle. The term “powder coating particle” refers to a paint embodied in solid particulate form as opposed to liquid form. The powder coating particle can comprise a solid particulate powder that is free flowing. As used herein, the term “free flowing” with regard to a solid particulate powder refers a solid particulate powder having a minimum of clumping or aggregation between individual particles.

The present invention also includes powder coating compositions produced according to these methods. The powder coating particle is capable of binding with the effect pigment and can be combined with other components to form a powder coating composition. The term “powder coating composition” refers to a pre-mix, extrudate and/or final ground powder.

The powder coating compositions used with the present invention can include a variety of thermosetting powder coating compositions known in the art. As used herein, the term “thermosetting” refers to compositions that “set” irreversibly upon curing or crosslinking, wherein polymer chains of polymeric components are joined together by covalent bonds. This property is usually associated with a cross-linking reaction of the composition constituents often induced, for example, by heat or radiation. Once cured, a thermosetting resin will not melt upon the application of heat and is largely insoluble in solvents.

The powder coating compositions used with the present invention can also include thermoplastic powder coating compositions. As used herein, the term “thermoplastic” refers to compositions that include polymeric components that are not joined by covalent bonds and, thereby, can undergo liquid flow upon heating.

The powder coating composition of the present invention includes a binder. As used herein, a “binder” refers to a main constituent material that holds all components of the composition together upon curing of the composition after application applied to a substrate. The binder includes one or more, such as two or more, film-forming resins. As used herein, a “film-forming resin” refers to a resin that can form a self-supporting continuous film on at least a horizontal surface of a substrate upon curing. Further, as used herein, the term “resin” is used interchangeably with “polymer,” and the term polymer refers to oligomers and homopolymers (e.g., prepared from a single monomer species), copolymers (e.g., prepared from at least two monomer species), terpolymers (e.g., prepared from at least three monomer species), and graft polymers.

The binder may be an organic binder suitable for use in a powder coating composition. Examples of organic binders may include but are not limited to thermoset and/or thermoplastic materials, and may comprise epoxy, polyester, polyurethane, polyamide, acrylic, polyvinylchloride, nylon, fluoropolymer, silicone, other resins, or combinations thereof. Thermoset materials, such as epoxies, polyesters and acrylics, for example, may be suitable for use as organic binders in powder coating applications. Elastomeric resins may be also used for certain applications.

Examples of suitable binders may include, but are not limited to: carboxyl-functional polyester resins cured with epoxide-functional compounds (e.g., triglycidyl-isocyanurate), carboxyl-functional polyester resins cured with polymeric epoxy resins, carboxyl-functional polyester resins cured with hydroxyalkyl amides, hydroxyl-functional polyester resins cured with blocked isocyanates or uretdiones, epoxy resins cured with amines, epoxy resins cured with phenolic-functional resins, epoxy resins cured with carboxyl-functional curatives, carboxyl-functional acrylic resins cured with polymeric epoxy resins, hydroxyl-functional acrylic resins cured with blocked isocyanates or uretdiones, unsaturated resins cured through free radical reactions, silicone resins used either as the sole binder or in combination with organic resins, polyvinylidene fluoride (PVDF) resins, PVDF resins cured with acrylic resin, fluoroethylene vinyl ether (FEVE) resins, and FEVE resins cured with polyether.

The organic binder may have a Tg of about 20° C. or greater, about 30° C. or greater, about 40° C. or greater, about 50° C. or greater, about 60° C. or greater, about 70° C. or less, about 80° C. or less, about 90° C. or less, about 100° C. or less, about 110° C. or less, about 120° C. or less, about 130° C. or less, or any value or range encompassed by these endpoints. For example, and in some embodiments, the organic binder may have a Tg in a range between 40° C. and 80° C.

Non-limiting examples of suitable film-forming resins include (meth)acrylate resins, polyurethanes, polyesters, polyamides, polyethers, polysiloxanes, epoxy resins, vinyl resins, copolymers thereof, and combinations thereof. As used herein, “(meth)acrylate” and like terms refer both to the acrylate and the corresponding methacrylate. The resin may also include epoxy/polyester hybrid resins and/or acrylic resins, fluoropolymer or fluoropolymer-based resins (such as FEVE and PVDF).

Further, the film-forming resins can have any of a variety of functional groups including, but not limited to, carboxylic acid groups, amine groups, epoxide groups, hydroxyl groups, thiol groups, carbamate groups, amide groups, urea groups, isocyanate groups (including blocked isocyanate groups), and combinations thereof.

Thermosetting coating compositions typically comprise a crosslinker that may be selected from any of the crosslinkers known in the art to react with the functionality of one or more film-forming resins used in the powder coating composition. The binder may therefore also include a crosslinker. As used herein, the term “crosslinker” refers to a molecule comprising two or more functional groups that are reactive with other functional groups and that is capable of linking two or more monomers or polymers through chemical bonds. Alternatively, the film-forming resins that form the binder of the powder coating composition can have functional groups that are reactive with themselves; in this manner, such resins are self-crosslinking.

Non-limiting examples of crosslinkers include phenolic resins, amino resins, epoxy resins, beta-hydroxy (alkyl) amides (such as Primid), alkylated carbamates, (meth)acrylates (such as GMA), isocyanates, blocked isocyanates (including uretdiones), triglycidyl isocyanurates (TGIC), glycoluril, polyacids, anhydrides, organometallic acid-functional materials, polyamines, polyamides, aminoplasts, carbodiimides, polyacids (such as dodecanedioic acid), oxazolines, and combinations thereof.

It is appreciated that the binder can comprise various types of film-forming resins and optionally crosslinkers including any of the film-forming resins and optional crosslinkers previously described. For example, the film-forming resin can comprise an epoxy functional addition polymer, and the crosslinker can comprise a carboxylic acid functional material (such as DDDA); and/or the film-forming resin can comprise an hydroxyl functional polyester, and the crosslinker can comprise a blocked isocyanate. Other non-limiting examples include a carboxylic acid functional polyester resin, and a beta-hydroxy (alkyl) amide or triglycidyl isocyanurate crosslinker; and/or an epoxy functional resin, and a phenolic crosslinker. Also, the binder can comprise an epoxy resin with phenolic or amine crosslinker; an epoxy resin with carboxylic acid functional polyester; an acrylic resin blended with PVDF; an FEVE resin optionally blended with polyester and crosslinker.

A range of powder compositions can be used. The present invention may contain at a minimum a resin, and degassing agent. For example, the degassing agent is benzoin, but other agents may be used. The powder can also include one or more flow additives.

The powder particles have a range of glass transition temperatures comprising 40° C.-80° C. In an example, the Tg is about 60° C. The effect pigment concentration can be between 0.5 weight % and 20 weight % relative to the total solids weight of the coating composition; or 1 weight % to 15 weight % of the powder coating composition, based on the total solids weight of the coating composition. The effect pigment concentration can comprise up to 15 weight %, up to 10 weight %, or up to 5 weight % of the powder coating composition. The concentration can comprise a range of from 7 weight % to 12 weight % of the powder coating composition. The concentration can be determined by thermal analysis such as ash testing or thermogravimetric analysis (“TGA”).

The powder coating composition can include other optional materials. For example, the powder coating composition can also comprise a colorant. As used herein, “colorant” refers to any substance that imparts color and/or other opacity and/or other visual effect to the composition. It is to be understood that a colorant as described herein is a separate component of the powder coating composition, unrelated to an effect pigment particle. As such, although effect pigments may impart a color to the powder coating, colorants are understood not to encompass effect pigment particles. The colorant can be added to the coating in any suitable form, such as discrete particles, dispersions, and/or solutions. The colorant can additionally or alternatively comprise a dye. Example colorants include, but are not limited to, those that are solvent and/or aqueous based such as phthalo green or blue, iron oxide, bismuth vanadate, anthraquinone, and peryleneand quinacridone. Other suitable colorants may include quinacridon, diketopyrrolopyrrole, isoindolinone, indanthrone, perylene, perynone, anthraquinone, dioxazine, benzoimidazolone, triphenylmethane quinophthalone, anthrapyrimidine, chrome yellow, pearl mica, transparent pearl mica, colored mica, interference mica, phthalocyanine, phthalocyanine halide, azo pigment (azomethine metal complex, condensed azo etc.), titanium oxide, carbon black, iron oxide, copper phthalocyanine, condensed polycyclic pigment, and the like. A single colorant or a mixture of two or more colorants can be used in the coatings of the present invention.

In general, the colorant can be present in any amount sufficient to impart the desired visual and/or color effect. The colorant may comprise from about 1 wt. % or greater, about 5 wt. % or greater, about 10 wt. % or greater, about 15 wt. % or greater, about 20 wt. % or greater, about 25 wt. % or greater, about 30 wt. % or greater, about 35 wt. % or less, about 40 wt. % or less, about 45 wt. % or less, about 50 wt. % or less, about 55 wt. % or less, about 60 wt. % or less, about 65 wt. % or less, or any range or value encompassed by these endpoints, based on the total weight of the compositions.

Example colorants include pigments (organic or inorganic), dyes and tints, such as those used in the paint industry and/or listed in the Dry Color Manufacturers Association (DCMA), as well as special effect compositions. A colorant may include, for example, a finely divided solid powder that is insoluble, but wettable, under the conditions of use. A colorant can be organic or inorganic and can be primarily agglomerated or non-agglomerated.

Example pigments and/or pigment compositions include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, iron oxide and mixtures thereof. Colorant pigments differ from the effect pigments in that the colorant pigments are agglomerates, whereas effect pigment are not. Color of color pigments is adjustable by reducing the size of the agglomerate. Colorant pigments can be from natural and synthetic sources and made of organic or inorganic constituents. A pigment can also be used as a flop control agent. A pigment is usually not soluble in a coating composition and can withstand extrusion without significant damage or degradation.

Other non-limiting examples of components that can be used with the powder coating composition of the present invention include plasticizers, abrasion resistant particles, fillers including, but not limited to, inert materials, such as BaSO₄/Al(OH)₃, micas, talc, clays, and inorganic minerals, anti-oxidants, hindered amine light stabilizers, UV light absorbers and stabilizers, surfactants, surface control agents, thixotropic agents, catalysts, reaction inhibitors, corrosion-inhibitors, flow additives, and other customary auxiliaries.

### IV. Mixing of Effect Pigments and Powder Coating Particles

Methods of the present invention can improve incorporation of effect pigments into coating compositions. It is believed these methods work by enabling the effect pigment to remain intact and largely undamaged during mixing and better disperse in the composition thereby resulting with more effective production of coatings that demonstrate special color, appearance or sparkle effects. The methods can reduce the amount of break down in the effect pigments that can occur in typical mixing processes and that make for a less desirable coating color, appearance or effect. Methods that rely on extrusion or blades for combining effect pigment and powder particle may damage the pigment particle or flake by—fracturing, warping, and/or bending the particle or flake. Additionally, it is believed that use of this method could achieve the same look using less pigment than in a traditional method given the decreased breakdown of the pigment.

Included in the present invention is a method of consistently bonding powder coatings producing a final coating composition that uses acoustical mixing. Acoustic mixing uses low-frequency, high intensity acoustic energy. While mixing, a shear field is applied throughout the sample container. Acoustic mixing processes may be gentle enough that particles are not broken down or degraded during mixing. Furthermore, acoustic mixing may provide more homogeneous coatings through even distribution of particles, as well as association between dissimilar particles. Finally, shorter mixing times in comparison to those required by other techniques may save time and resources.

The powder coating composition of the present invention is prepared by mixing the powder coating particles with the effect pigments using acoustic energy. The term “acoustic energy” as used herein means a disturbance of energy which passes through matter in the form of a wave or mechanical vibrations. The acoustic energy can be imparted or imposed on the effect pigments and powder coating particles causing them to mix. The mixture is produced without use of a contact blade. A resonant-vibratory device or other instrument can be used to propagate or generate acoustic energy which creates oscillations or resonance conditions to mix the pigments and particles. Non-limiting examples of vibratory instruments include Appikon's RAMbio, Resonance Acoustic Mixer and Resodyn's Lab Ram mixer.

For instance, in the present invention the instrument may contain a vessel or container into which the powder coating particles and effect pigments are loaded. The powder coating particles and effect pigments may be dispersed or pre-combined prior to loading them into the equipment. Alternatively, the powder particles may be loaded into the container followed by placement of the effect pigments on top of the powder particles prior to mixing.

Resonant acoustic mixing is distinct from the conventional impeller agitation process used by planetary or ultrasonic mixers. The low frequency, high-intensity acoustic energy creates a uniform shear field throughout the entire mixing vessel, resulting in rapid fluidization and dispersion of material.

More specifically, resonant acoustic mixing differs from ultrasonic mixing in the frequencies of acoustic energy used. In resonant acoustic mixing, the frequency of acoustic energy is orders of magnitude lower, permitting for larger scale mixing. Resonant acoustic mixing also differs from impeller agitation, which mixes by inducing bulk flow. In contrast, acoustic mixing occurs on a microscale throughout the entire volume of the mixture.

During acoustic mixing, acoustic energy is delivered to the components to be mixed. Motion is created in a mechanical system consisting of engineered plates, springs, and eccentric weights. The energy thus created may then be transferred acoustically to the components to be mixed. A resonant acoustic mixing system operates at resonance, during which the exchange of energy between the mechanical elements and the components undergoing mixing is nearly complete, as the only element that absorbs energy (aside from small losses to friction) is the mix load, resulting in a highly efficient process.

The resonant frequency can be about 5 Hertz or greater, about 10 Hertz or greater, about 15 Hertz or greater, about 20 Hertz or greater, about 25 Hertz or greater, about 30 Hertz or greater, about 40 Hertz or greater, about 50 Hertz or greater, about 60 Hertz or greater, about 70 Hertz or less, about 80 Hertz or less, about 90 Hertz or less, about 100 Hertz or less, about 110 Hertz or less, about 120 Hertz or less, about 130 Hertz or less, about 140 Hertz or less, about 150 Hertz or less, or any value encompassed by these endpoints.

The acoustic energy used in the present invention is used at a low frequency energy to mix the effect pigment and powder particle together. In addition, an amplitude range and frequency range can be defined that results in mixing of the powder coating particles with the effect pigments. For instance, the acoustic energy comprises an amplitude range of 0.02 inches to about 0.5 inches and a frequency of 5 hertz to 150 hertz. The energy is imparted to produce a mixture of effect pigments and powder coating particles.

### V. Bonding of Effect Pigments and Powder Coating Particles

The mixture of powder coating particles and the effect pigments is heated to physically adhere, or bond, the effect pigments to the powder coating particles. Heating can be achieved internally or through use of an external source. Internal generation can result from the friction of particles moving from the acoustic energy. In the case of acoustic energy, the energy can be generated through linear motion via gravitational acceleration, which can reach up to 100 Gs of acceleration, and may slightly heat the mixture. Thus, a minimal heat may be generated from the mixing process itself. Alternatively, an external source can be used to heat the mixture. The container can include an adapted heat source, such as a flame or thermal jacket. The heating can be controlled relative to the powder particle's glass transition temperature or Tg.

The heating step continues for a sufficient amount of time. As used herein the term “sufficient amount of time” means the amount of time needed to heat the mixture to cause the powder particles to become tacky enabling the effect pigment to physically adhere to the powder particle. This may be until the temperature of the powder mixture within the vessel is near to the Tg of the powder particles. In other words, heating occurs at a temperature near the softening point of the film-forming resin while avoiding the material clumping together and below a temperature at which significant crosslinking or pre-reaction would occur.

Physical adherence can be determined by a variety of methods such as electron microscopy or visual inspection. By visual inspection, adherence of effect pigment to the resin powder particles can be confirmed by an absence of significant color shift. If no more than a minimal color shift is observed when comparing powder applied under different electrostatic conditions (such as voltage or air pressure variations), adherence has occurred.

The heated mixture is then cooled back down to a temperature below the Tg of the powder particle or a temperature at which agglomeration of the particles is no longer a concern. At this point the powder will return to its solid granular form. While cooling, the mixture can continue to be mixed until cooled to ensure powder agglomeration does not occur. Cooling the mixture can include air cooling or water/fluid cooling. In the present invention it is anticipated the heating and cooling steps may strictly sequential. Optionally, they are not sequential. The mixing may occur by batch or continuous process. For example, in the case of a continuous mixing process, a continuous flow-through resonant acoustic mixer may be utilized, such as a Resodyn® RAM 5 and/or RAM 55 mixer, whereas the powder coating particles and effect pigment particles are mixed in a continuous fashion via acoustic energy. In this case, the continuous processing may be based upon powder coating load, acceleration, and resonance time, whereas it may be possible to continuously process between 2,200 kg and 25,000 kg of the powder coating mixture per hour via the the continuous mixing process.

### VI. Spraying of Powder Coating Mixture

Suitable uses for the process of the present invention include any uses where powder coating particles may be desired. Powder coating may involve the application of a dry, free flowing powder to a surface. The electrostatically charged powder is directed to a grounded component, thereby forming the coating layer. Following application, the powder coating is cured via the application of heat, during which the powder melts and flows to form a cured coating. The lack of solvent in powder coating compositions may make this method desirable as a non-polluting option, as the compositions may be free of added or organic solvents.

Powder coating mixtures containing two or more powders with dissimilar densities, dissimilar electrostatic properties, hold a change differently, and/or different flow behaviors, which may result in non-homogeneous powder mixtures and changing concentrations of powder coating on coated components. To avoid this problem, a powder combination may be mixed to form a homogeneous powder prior to powder coating, which can include the effect pigments as described previously, thereby producing a homogeneous topcoat layer.

The electrostatic gun may have a round spray nozzle/tip or a flat spray nozzle/tip. The electrostatic spray gun may spray the powder coating mixture at a variety of pressures, which may adjusted to achieve a desired powder coating finish and/or effect. For example the powder coating mixture may be sprayed at about 1 psig or greater, about 5 psig or greater, at about 20 psig or greater, at about 25 psig or greater, at about 30 psig or greater or about 40 psig or less, at about 50 psig or less, about 60 psig or less, or any value encompassed by these endpoints. The electrostatic gun may comprise at least one electrode and a high-voltage generator. The high-voltage generator may generate a negative polarity to be applied to the electrode during application of the powder coating composition. The high-voltage generator can generate a negative polarity voltage of about 0 KV or greater, about 1 KV or greater, about 10 KV or greater, about 20 KV or greater, about 30 KV or greater, about 40 KV or greater, about 50 KV or less, about 60 KV or less, about 70 KV or less, about 80 KV or less, about 90 KV of less, about 100 KV or less, or any value encompassed by these endpoints.

Many end-use products today have a metallic appearance, including appliances, office furniture, architectural extrusions, automotive trim, and general industrial products.

### VII. Powder Coating Performance

The performance of an applied powder coating can be based upon a variety of factors including the “lightness” (e.g., L value), of the powder coating. Lightness of the coating may be the amount of light that is refracted by the surface of the powder coating at a given angle of refraction. Typically, lower L values represent darker colors, however, in the case of powder coatings the contain effect pigments, a higher L value may indicate the amount of effect, such as sparkle, glint, and/or glitter, generated by inclusion of the effect pigment in the powder coating. For example, in the case of a dark colored powder coating (e.g., black), the amount of effect pigment particles present in the powder coating composition may greatly increase the L value of the resulting powder coating, as compared to a powder coating composition that lack effect pigment particles. Therefore, a higher L value may be a desirable quality of the performance of a powder coating since a higher L value indicates how sparkly, glinty, and/or glittery the powder coating appears.

The L value may also be used to extrapolate other performance characteristics of the powder coating. For instance, the L value may be indicative of the effectiveness of the bonding method used during adhesion of the effect pigments to the additional components of the powder coating. As a first example, the powder coating mixture may include relatively large effect pigment particles (e.g., effect pigment particles with d50 diameters greater than about 20 μm). this case, the powder coating particles and/or additional additives of the powder coating mixture bond to the outside surface of the larger effect pigment particle (e.g., the smaller powder coating particles bonded to the outside of the larger effect pigment particles). In this scenario, the greater the extent of bonding of the various powder coating components to the surface of the effect pigment particles results in a more sparkly, glinty, or glittery powder coating, and is measureable as a higher L value. As a second example, the powder coating mixture may include relatively small effect pigment particles (e.g., effect pigment particles with d50 diameters of less than about 20 μm) In this case, the effect pigment particles bond with the binder and/or additional additives of the powder coating mixture, such that the smaller effect pigment particles bond to the outside surface of the larger powder coating particles. In this scenario, the higher the extent of bonding of the effect pigment particles to the outside surface of the various other powder coating components results in a more sparkly, glinty, or glittery powder coating, and is measureable as a higher L value. As such, in either case, a higher L value may indicate the effectiveness of the mixing method, and particularly, the bonding of the effect pigment particles with the various other powder coating particle components, whereas a higher L value results in a higher powder coating performance.

The consistency of the L values between the same powder coating formulation applied under different spray conditions may also be a desirable quality of powder coating performance. For example, in the case where a powder coating is applied under two differing spray conditions (e.g., 10 psi and 30 psi, by two different nozzles, two different voltages (e.g., kV), etc.), the less of a difference in the resulting L values (e.g., a ΔL value) measured between the two powder coatings is indicative of the consistency between applications. Consistency between two powder coating applications is a desirable performance characteristic of a powder coating. In this case, a high degree of consistency (e.g., a low ΔL value) between two different powder coating applications may indicate that the powder coating formulation can be used under differing industrial conditions, yet yield similar powder coated products. As such, consistency may be regarded as relating to flexibility in that a consistent powder coating formulation may be flexibly applied under different operational conditions yet yield similar and reproducible powder coated items. Additionally, consistency of the L values may also indicate a relationship to the ability to re-claim and reuse any oversprayed powder coating. In this case, when consistently applied under a variety of conditions, overspray of the powder coating mixture can be reclaimed and recycled during the powder coating application process. In this regard, since the effect pigment particles are thoroughly de agglomerated, distributed throughout the powder coating mixture, and effectively bonded, accumulation in the concentration of the effect pigment particles in the reclaimed and recycled powder coating mixture can be avoided. Therefore, high consistency of the L value under different application conditions may indicate a heightened ability to reclaim and reuse the oversprayed powder coating.

The ΔL value may also be used to extrapolate other performance characteristics of the powder coating. For instance, in the case of powder coating formulations that include effect pigments, the ΔL value may indicate the effectiveness of the mixing of the effect pigments with the other components of the powder coating mixture. For example, in the case of smaller effect pigment particles (e.g., effect pigment particles with d50 diameters of less than about 20 μm), thorough mixing requires the de-agglomeration of any clumps of effect pigment particles (e.g., agglomerated effect pigment particles) as well as the thorough dispersion of the de-agglomerated effect pigment particles throughout the powder coating mixture. As such, a low ΔL value may indicate the effectiveness of the de-agglomeration and mixing of the effect pigment particles since, with a more thoroughly mixed powder coating mixture, the larger chunks of the effect pigments would have been de-agglomerated and more effectively dispersed throughout the powder coating mixture, resulting in a more even distribution of the effect pigment particles under differing spray conditions.

Conventional mixing techniques utilized to mix effect pigments into the powder coating mixture can include, among others, high intensity-high shear mixing and shaking-type mixing. As described above, in the case of high intensity-high shear type mixing, a shear device (e.g., a blade) is used to mix the components of the powder coating mixture together. In the case of a shaking-type mixing, the components of the powder coating are shaken so that the effect pigment is thoroughly mixed with the additional components of the powder coating by lateral torsional force. Bonding of the effect pigment particles to the additional components of the powder coating can be performed by heating the vessel containing the mixed powder coating material, whereas the effect pigments particles bond with the other components of the powder coating mixture at a transitional temperature. When utilizing either the shaking-type or high-shear type mixing/bonding methods, certain benefits and drawbacks to the performance of the resulting powder coating can be observed.

For example, high intensity-high shear mixing may beneficially de-agglomerate granules of effect pigment particles and thoroughly mix such particles throughout the powder coating mixture. In this case, it would be expected that high intensity-high shear mixing would yield low ΔL values since the powder coating mixture may be thoroughly mixed. However, the high-shear forces and/or contact with the shear mixing blade may damage the structure of the individual effect pigment particles and/or the outer protective coating of the effect pigment particles. This may result either in a lower L value due to the damage suffered by the effect pigment particles (e.g., breaking the individual effect pigments into pieces and/or rendering the outer coating ineffective), and/or may result in an unexpectedly high ΔL values due to the broken effect pigment particles effecting the bonding characteristics of the powder coating mixture (e.g., broken particles not bonding to the same degree as unbroken effect pigment particles), resulting in inconsistent powder coating applications under different spray conditions (e.g., the differential of the L value between of low and high pressure spraying). Therefore, even though high intensity-high shear type mixing may thoroughly mix the effect pigments into the powder coating mixture, the mixing may be too forceful to generate desirable powder coating performance.

In a second example, shaking-type mixing may beneficially preserve the structure of the individual effect pigments during mixing since the mixing is gentle. However shaking-type mixing does not provide the necessary force to de-agglomerate clumps of effect pigments and/or additional powder coating components, and as such, the resulting powder coating may demonstrate both a low L value (e.g., due to not breaking up the agglomerates of effect pigment particles) as well as a high ΔL value, since the effect pigments may be inconsistently dispersed throughout the powder coating mixture.

Acoustic mixing of effect pigment particles results in many desirable powder coating performance characteristics. As described previously, acoustic mixing may utilize low frequency acoustical energy to mix the effect pigment particles with the additional components of the powder coating mixture. In this case, bonding may occur either by the acoustical energy provided during the mixing (e.g., the vibrational forces gently heating the powder coating mixture to the transitional temperature of the powder coating particle), or may be provided by a secondary heating device. In this case, the acoustical energy may be sufficient to de-agglomerate any chunks of effect pigments and/or powder coating components, provide sufficient gradual heating to bond the effect pigment particles to the additional powder coating components, and may also be gentle enough to avoid damaging the individual effect pigment particles by use of the acoustical energy. As such, acoustical mixing of the effect pigment particles yield higher performance powder coatings by, firstly, avoiding the problems associated with shaker type mixing through thoroughly de-agglomerating and dispersing the effect pigment particles and/or powder coating components while secondly avoiding the problems associated with high intensity-high shear type mixing through avoiding breakage of the effect pigment particles during de-agglomeration. As such, acoustical mixing may be particularly advantageous over other mixing methods for mixing effect pigments into powder coating mixtures.

For example, the acoustical mixing of smaller effect pigments (e.g., effect pigment particles with d50 diameters of less than about 20 μm) may result in L values of the applied powder coating being substantially higher than shaker type mixing (e.g., shaker type mixing resulting in relatively low L values due to ineffective de-agglomeration of clumps of smaller effect pigment particles) and results in similar, if not higher, L values as compared to high intensity-high shear type mixing (whereas high intensity-high shear mixing effectively de-agglomerates the effect pigment particles). In this case, the acoustical mixing of smaller effect pigments may result in smaller ΔL values between two different conditions of applications of the same powder coating as compared with high intensity-high shear type mixing, which is indicative of the acoustical mixing providing sufficient energy to mix and de-agglomerate the effect pigment particles, and yet avoid damaging such effect pigment particles. Additionally, the lower ΔL values are indicative of the effectiveness of the bonding provided by the acoustical mixing process (e.g., by the gentle heating of the effect pigment particles by the acoustical energy and or by the additional heating provided by a secondary source during the acoustical mixing process), which results in a more thorough dispersion of the effect pigments into the bonded powder coating mixture. As such, in the case of smaller effect pigment particles, acoustical mixing may provide a more sparkly, glinty, or glittery powder coating (e.g., a higher L value powder coating) that is substantially more flexibly and consistently applied (e.g., a low ΔL powder coating) than powder coatings mixed by other methods.

As a second example, the acoustical mixing of larger effect pigments (e.g., effect pigment particles with d50 diameters greater than about 20 μm) may result in L values of the applied powder coating being higher than shaking-type mixing (e.g., shaker type mixing resulting in relatively low L values due to ineffective mixing of larger effect pigment particles) and similar, if not higher, L values as compared to high intensity-high shear type mixing. In this case, the acoustical mixing of larger effect pigments may also result in smaller ΔL values between two different conditions of applications of the same powder coating as compared with high intensity-high shear type mixing, which is indicative of the acoustic mixing providing sufficient energy to mix the larger effect pigment particles yet avoid damaging the effect pigment particles. Additionally, the lower ΔL values are indicative of the effectiveness of the bonding provided by the acoustical mixing process (e.g., by the heating of the effect pigment particles by the acoustical energy and or by the additional heating provided by a secondary source during the acoustical mixing process), which results in a more thorough dispersion of the effect pigments into the bonded powder coating mixture. As such, in the case of smaller effect pigment particles, acoustical mixing may provide a more sparkly, glinty, or glittery powder coating (e.g., a higher L value powder coating) that is substantially more flexibly and consistently applied (e.g., a low ΔL powder coating) than powder coatings mixed by other methods.

Experimental exemplifications of the forgoing effects of the acoustical mixing are provided herein, whereas acoustical mixing, high intensity-high shear type mixing, and shaker type mixing are compared in examples 1 through 4 below.

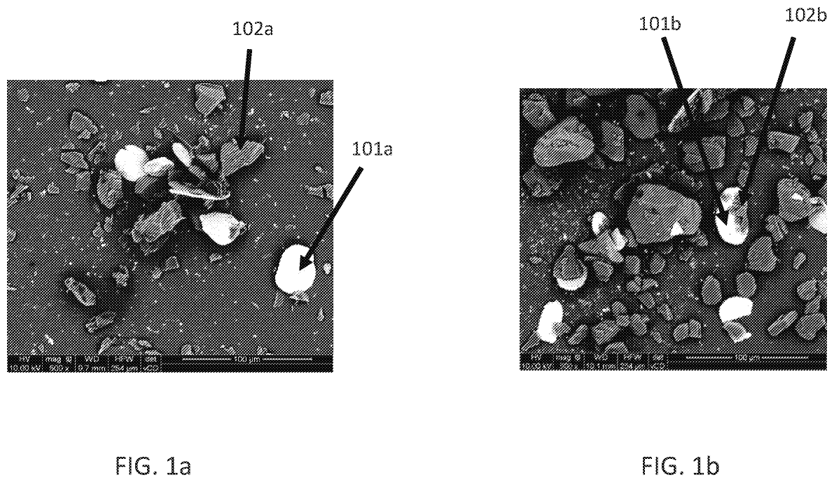

Additionally, FIGS. 1A and 1B illustrate the effectiveness of the acoustical mixing of larger effect pigments as compared to high intensity-high shear type mixing. In this case, FIG. 1A shows a scanning electron microscopic image of a an applied powder coating whereas high intensity-high shear type mixing was used to mix the effect pigments, while FIG. 1B shows a scanning electron microscopic image of the same applied powder coating formulation mixed by acoustical mixing. In both cases, the large effect pigment particles 101 are Standart PCA 3500 particles, and the base powder particles 102 are PPG Envirocron® PCU75139.

As shown in FIG. 1A, the base powder particles 102a are separate from the effect pigment particles 101a whereas very little adhesion of the base powder particles 102a to the effect pigment particles 101a has occurred. This is indicative of low performance of the high intensity-high shear type mixing powder coating since there is very little adhesion between the two particle types 101a and 102a. As shown in FIG. 1B, the base powder particles 102b are substantially adhered to the outside surface of the effect pigment particles 101b. This is indicative of high performance of the acoustically mixed powder coating since there is substantial adhesion between the two particle types 101b and 102b.

### EXAMPLES

### Example 1: Unbonded Dry Blend Pigments

Ten different effect pigments were added a base powder. In runs 1-10, the base powder was a black polyester urethane powder coating. In run 11, the base powder was PPG Envirocron® PCST99104, a black polyester powder coating with hydroxyl alkyl amide (HAA) crosslinker commercially available from PPG. Finally, in run 12, the base powder was PPG Coraflon® PCNT98100, a black fluoropolymer powder coating, commercially available from PPG.

The pigments were commercially available from Eckart (Standart PCA 9155, Standart PCU 3500, Standart PC 200, STAY/STEEL 316L K Flake, and STANDART RESIST CT Rich Pale Gold), Schlenk (Powdal 2900 and Powdal 3200), Merck/EMD Performance Materials (Xirallic T60-10SW Crystal Silver and Iriodin 9119 Polar White Mica) and BASF (Mearlin Sparkle 139P Mica).

In each run, the pigment was combined with the base powder in a bag. The bag was then shaken vigorously for five minutes to thoroughly mix the pigment with the base powder. The pigments, along with the concentrations in which they were combined in with the base powder are shown below in Table 1.

TABLE 1

| | | | | Effect |
|---|---|---|---|---|
| Run | Base | | | Pigment |
| # | powder | Effect Pigment | Description | Wt. % |
| 1 | Black | STANDART PCA | Polymer-coated | 3.0 |
| | Polyurethane | 9155 | aluminum pigment | |
| 2 | Powder | STANDART PCU | Polymer-coated | 3.0 |
| | | 3500 | aluminum pigment | |
| 3 | | Powdal 2900 | SiO₂-stabilized | 1.15 |
| | | | aluminum pigment | |
| 4 | | Powdal 3200 | SiO₂-stabilized | 2.0 |
| | | | aluminum pigment | |
| 5 | | STANDART PC | Aluminum pigment | 1.0 |
| | | 200 | | |
| 6 | | STANDART Stay | Stainless steel | 5.0 |
| | | Steel 316L | pigment | |
| 7 | | Xirallic T60-10SW | Alumina pigment | 6.0 |
| | | Crystal Silver | | |
| 8 | | Iriodin 9119 Polar | Mica pigment | 6.0 |
| | | White | | |
| 9 | | Mearlin Sparkle | Mica pigment | 3.0 |
| | | 139P | | |
| 10 | | STANDART | SiO₂-coated | 3.0 |
| | | RESIST CT Rich | metallic pigment | |
| | | Pale Gold | | |
| 11 | PCST99104 | STANDART PCA | Polymer-coated | 3.0 |
| | | 9155 | aluminum pigment | |
| 12 | PCNT98100 | STANDART PCA | Polymer-coated | 3.0 |
| | | 9155 | aluminum pigment | |

The pigments varied in shape and average diameter. These values are shown below in Table 2.

TABLE 2

| Component | Shape | D50 (μm) |
|---|---|---|
| STANDART PCA 9155 | Cornflake | 16 |
| STANDART PCU 3500 | Cornflake | 35 |
| Powdal 2900 | Cornflake | 11 |
| Powdal 3200 | Silver dollar | 56 |
| STANDART PC 200 | Cornflake | 4 |
| STAY/STEEL 316L K Flake | Cornflake | 35 |
| Xirallic T60-10SW Crystal Silver (Al₂O₃) | Platelets | 18 |
| Iriodin 9119 Polar White Mica | Platelets | 10 |
| Mearlin Sparkle 139P Mica | Platelets | 39 |
| STANDART RESIST CT Rich Pale Gold | Cornflake | 26 |

The formulations were neither heated nor cooled during mixing. The mixed formulations therefore comprised unbonded pigments.

### Example 2: Pigment Bonding Via Traditional Method

Bonding was done by traditional method in a PLAS MEC RV 10/20 laboratory mixer (model #11604604). The dry blend powders mixtures described above were added to the PLAS MEC mixer under nitrogen atmosphere. The mixer was run at 2100 rpm to achieve the bonding temperature via the friction of mixing. Once at the bonding temperature, the rpms were set to 1600 and adjusted +200 rpm as such that temperature remained constant. The sample was held for 300 seconds before being cooled to room temperature. The conditions for each run are shown below in Table 3.

TABLE 3

| Run | Powder | Bonding | Bonding | |
|---|---|---|---|---|
| # | Blend | Temp., ° F. | Time, s | RPM |
| 13 | Run 1 | 150 | 300 | 1600 |
| 14 | Run 2 | 150 | 300 | 1600 |
| 15 | Run 3 | 150 | 300 | 1600 |
| 16 | Run 4 | 150 | 300 | 1600 |
| 17 | Run 5 | 150 | 300 | 1600 |
| 18 | Run 6 | 150 | 300 | 1600 |
| 19 | Run 7 | 150 | 300 | 1600 |
| 20 | Run 8 | 150 | 300 | 1600 |
| 21 | Run 9 | 150 | 300 | 1600 |
| 22 | Run 10 | 150 | 300 | 1600 |
| 23 | Run 11 | 147 | 300 | 1600 |
| 24 | Run 12 | 120 | 300 | 1600 |

Fumed aluminum oxide (0.1%) was then added to the bonded powder as a flow agent for spray application. The bonded powder was then sieved through a 100-mesh sieve to remove agglomerates formed during the bonding process. It is anticipated that the mixing blades will cause damage to the larger flakes, causing them to fracture and reduce in size.

### Example 3: Pigment Bonding Via Resonant Acoustic Mixing

To a metal container was added a dry blend powder as described above to a fill volume of approximately 75%. The container was placed into a jacketed vessel on a LabRAM II mixer equipped with a jacketed vessel connected to both a chiller and heater in order to control the temperature in the mixer. The unit was closed and turned on at an acceleration setting indicated in Table 4 as “Accel. 1”. Temperature-controlled water baths were used to achieve the temperature listed in Table 4 as “Temp. 1”. It should be understood that with more aggressive mixing, frictional heat is generated, and cooling is required to maintain the temperature in the desired range. Conversely, to achieve the bonding temperature with less aggressive mixing, heating is required. For larger, easily damaged flakes, a single step was used with less aggressive mixing.

TABLE 4

| | | | Accel. | Time | Temp | Accel. | Time | Temp |
|---|---|---|---|---|---|---|---|---|
| Run | Powder | Mass | 1 | 1 | 1 | 2 | 2 | 2 |
| # | Blend | (g) | (G) | (min) | (° C.) | (G) | (min) | (° C.) |
| 25 | Run 1 | 215 | 30 | 10 | 39 | 30 | 10 | 65 |
| 26 | Run 2 | 215 | 50 | 15 | 65 | n/a | n/a | n/a |
| 27 | Run 3 | 215 | 50 | 10 | 10 | 50 | 10 | 65 |
| 28 | Run 4 | 215 | 50 | 10 | 64 | n/a | n/a | n/a |
| 29 | Run 5 | 215 | 90 | 10 | 64 | n/a | n/a | n/a |
| 30 | Run 6 | 215 | 50 | 5 | 14 | 50 | 10 | 65 |
| 31 | Run 7 | 215 | 50 | 5 | 12 | 50 | 10 | 65 |
| 32 | Run 8 | 215 | 50 | 5 | 14 | 50 | 10 | 65 |
| 33 | Run 9 | 215 | 50 | 5 | 12 | 50 | 10 | 64 |
| 34 | Run 10 | 215 | 50 | 10 | 64 | n/a | n/a | n/a |
| 35 | Run 11 | 215 | 95 | 10 | 60 | n/a | n/a | n/a |
| 36 | Run 12 | 250 | 50 | 5 | 48 | 35 | 10 | 57 |

### Example 4: Electrostatic Spray Film Formation

The powders from Examples 1-36 were added to a fluidized feed hopper (Nordson HR-1-4) and fluidized with clean dry air. The powder was then electrostatically applied (via Nordson Encore electrostatic spray gun) to grounded metal panels at 75 kV under two different flow rates (10 psi and 30 psi). The panels were baked in an electric oven at 191° C. for 20 minutes to yield cured films at approximately 3 mils film thickness. Color readings were taken on an X-rite MA68II multi-angle spectrophotometer with readings taken at a 45-degree angle. The measurements generally used the methods described in ASTM E2194-14, with the exception that a standard tile was not measured after calibration of the unit.

In Table 5 below, the blends are grouped based upon their base powder and pigment (i.e., runs 37, 38, and 39 use blends comprising a black polyurethane powder as the base powder and STANDART PCA 9155 as the pigment, as shown in Example 1. The method of mixing for each run varies, as described in Examples 1, 2, and 3; i.e., the dry blend method for blends 1-12, lab mixer for blends 13-24, and resonant acoustic mixing for blends 25-36.

The L value for each run is also provided in Table 5 for both the 30 psi and 10 psi flow rates. The Commission Internationale d'Eclairage (CIE) provides a method of describing colors using a color space measurement referred to as L*a*b*. A color is defined using a red/green coordinate (a*), a yellow/blue coordinate (b*), and a measure of lightness (L), which may be defined as a measure of how much light is refracted by the color on a scale of 0-100, with lower values representing darker colors. As used herein, the change in L (ΔL) may be defined as the difference in how much light is refracted by coatings sprayed at the 30 psi rate versus 10 psi. Finally, ΔL % of average may be defined as the difference in L for the average L value. This FIGURE may be calculated as shown below in Equation 1:

ΔL/[(L at 30 psi+L at 10 psi)/2]×100 Eq. 1:

This FIGURE may assist in determining how consistently a coating refracts light regardless of the flow rate at which it is applied.

TABLE 5

| | | | Effect | | | | Δ L as |
|---|---|---|---|---|---|---|---|
| | | | Pigment | | | | % of |
| Run | | Mixing | D50 | L @ | L @ | | average |
| # | Blend | Method | (μm) | 30 psi | 10 psi | Δ L | L |
| 37 | 1 | Dry Mix | 16 | 29.28 | 31.71 | 2.43 | 8.0 |
| 38 | 13 | High Shear | 16 | 45.88 | 45.18 | 0.70 | 1.5 |
| 39 | 25 | Acoustically | 16 | 44.12 | 44.15 | 0.03 | 0.1 |
| 40 | 2 | Dry Mix | 35 | 7.71 | 10.33 | 2.62 | 29.0 |
| 41 | 14 | High Shear | 35 | 22.95 | 20.68 | 2.27 | 10.4 |
| 42 | 26 | Acoustically | 35 | 25.49 | 23.21 | 2.28 | 9.4 |
| 43 | 3 | Dry Mix | 11 | 34.25 | 32.58 | 1.67 | 5.0 |
| 44 | 15 | High Shear | 11 | 41.61 | 41.29 | 0.32 | 0.8 |
| 45 | 27 | Acoustically | 11 | 35.49 | 35.67 | 0.18 | 0.5 |
| 46 | 4 | Dry Mix | 56 | 33.27 | 23.80 | 9.47 | 33.2 |
| 47 | 16 | High Shear | 56 | 23.68 | 22.34 | 1.34 | 5.8 |
| 48 | 28 | Acoustically | 56 | 27.35 | 27.76 | 0.41 | 1.5 |
| 49 | 5 | Dry Mix | 4 | 30.12 | 29.03 | 1.09 | 3.7 |
| 50 | 17 | High Shear | 4 | 42.51 | 42.29 | 0.22 | 0.5 |
| 51 | 29 | Acoustically | 4 | 41.41 | 41.67 | 0.26 | 0.6 |
| 52 | 6 | Dry Mix | 35 | 19.12 | 21.00 | 1.88 | 9.4 |
| 53 | 18 | High Shear | 35 | 18.46 | 19.03 | 0.57 | 3.0 |
| 54 | 30 | Acoustically | 35 | 18.01 | 18.35 | 0.34 | 1.9 |
| 55 | 7 | Dry Mix | 18 | 10.93 | 11.60 | 0.67 | 5.9 |
| 56 | 19 | High Shear | 18 | 16.22 | 17.53 | 1.31 | 7.8 |
| 57 | 31 | Acoustically | 18 | 17.14 | 17.29 | 0.15 | 0.9 |
| 58 | 8 | Dry Mix | 10 | 21.71 | 21.96 | 0.25 | 1.1 |
| 59 | 20 | High Shear | 10 | 32.84 | 32.66 | 0.18 | 0.5 |
| 60 | 32 | Acoustically | 10 | 34.64 | 35.27 | 0.63 | 1.8 |
| 61 | 9 | Dry Mix | 39 | 3.6 | 3.77 | 0.17 | 4.6 |
| 62 | 21 | High Shear | 39 | 9.41 | 9.64 | 0.23 | 2.4 |
| 63 | 33 | Acoustically | 39 | 8.94 | 8.73 | 0.21 | 2.4 |
| 64 | 10 | Dry Mix | 26 | 27.75 | 22.80 | 4.95 | 19.6 |
| 65 | 22 | High Shear | 26 | 25.27 | 25.24 | 0.03 | 0.1 |
| 66 | 34 | Acoustically | 26 | 25.09 | 26.98 | 1.89 | 7.3 |
| 67 | 11 | Dry Mix | 16 | 48.93 | 45.58 | 3.35 | 7.1 |
| 68 | 23 | High Shear | 16 | 51.70 | 51.99 | 0.29 | 0.6 |
| 69 | 35 | Acoustically | 16 | 48.99 | 49.31 | 0.32 | 0.7 |
| 70 | 12 | Dry Mix | 16 | 39.39 | 41.77 | 2.38 | 5.9 |
| 71 | 24 | High Shear | 16 | 52.66 | 52.33 | 0.33 | 0.6 |
| 72 | 36 | Acoustically | 16 | 49.35 | 47.93 | 1.42 | 2.9 |

As exemplified in Table 5, the effects of the acoustic mixing on differing effect pigment formulations typically resulted in L values, at either the 30 psig or 10 psig spray conditions, being at least similar, if not higher than the L values of the dry blend of the same effect pigment formulations sprayed under the same conditions. Additionally, the acoustically mixed formulations also displayed substantially lower ΔL values than the dry blend sprayed under the same conditions.

Also exemplified in Table 5, the effects of the acoustic mixing on differing effect pigment formulations typically resulted in L values, at either the 30 psig or 10 psig spray conditions, being at least similar, if not higher than the L values of the traditionally mixed effect pigment formulations sprayed under the same conditions. Additionally, the acoustically mixed formulations also displayed at least similar, if not lower, ΔL values than the dry blend sprayed under the same conditions.

As such, Table 5 indicates that the acoustically mixed effect pigments typically displayed higher L values and lower ΔL values than effect pigments mixed using either at shaken method or traditional high shear-high intensity mixing.

Whereas particular embodiments of this invention have been described above for purposes of illustration, it will be evident to those skilled in the art that numerous variations of the details of the present invention may be made without departing from the invention as defined in the appended claims.

### ASPECTS

Aspect 1 is a method for producing a powder coating mixture comprising: receiving effect pigment particles and powder coating particles; mixing the effect pigment particles with the powder coating particles, the mixing comprising imparting acoustic energy to the effect pigment particles and the powder coating particles; heating the effect pigment particles and the powder coating particles, the heating bonding the effect pigment particles to the powder coating particles; and cooling the bonded effect pigment particles and the powder coating particles.

Aspect 2 is a method of Aspect 1, wherein the effect pigment particles and the powder coating particles are mixed without the use of high shear forces.

Aspect 2 is a method of any one of Aspects 1 or 2, wherein the effect pigment particles and the powder coating particles are mixed without the use of a blade.

Aspect 3 is a method of any one of Aspects 1 through 3, wherein the effect pigment particles and the powder coating particles are mixed in a continuous process.

Aspect 4 is a method of any one of Aspects 1 through 4, wherein the received pigment particles comprise agglomerations of the effect pigment particles, and the acoustical energy imparted to the effect pigment particles de-agglomerates the agglomerated effect pigment particles.

Aspect 5 is a method of any one of Aspects 1 through 4, wherein the de-agglomeration of the effect pigment particles occurs without damaging a structure of the effect pigment particles.

Aspect 6 is a method of any one of Aspects 1 through 5, wherein the de-agglomeration of the effect pigment particles occurs without damaging an external surface of the effect pigment particles.

Aspect 7 is a method of any one of Aspects 1 through 6, wherein the heating comprises the use of heat generated internally from friction due to the acoustic energy.

Aspect 8 is a method of any one of Aspects 1 through 7, wherein heating further comprises the use of heat generated from an external source.

Aspect 9 is a method of any one of Aspects 1 through 8, wherein the heating step occurs in conjunction with the mixing step.

Aspect 10 is a method of any one of Aspects 1 through 9, wherein the heating step, the mixing step, and the cooling step each occur in conjunction.

Aspect 11 is a method of any one of Aspects 1 through 10, wherein the heating occurs for an amount of time to cause the powder particles to become tacky, and the tacky powder particles bond with the effect pigment particles.

Aspect 12 is a method of any one of Aspects 1 through 11, wherein the cooling begins once the powder particles become tacky.

Aspect 13 is a method of any one of Aspects 1 through 12, wherein the heating comprises heating the mixture to a temperature near to, or greater than, the Tg of the powder particles.

Aspect 15 is a method of any one of Aspects 1 through 14, the acoustic energy comprises an amplitude range of at least 0.02 inches to 0.5 inches and a frequency of 5 hertz to 150 hertz.

Aspect 16 is a powder coating composition comprising a thermosetting polymeric binder and metallic effect pigment particles, the thermosetting polymeric binder and metallic effect pigment particles mixed with acoustic energy and heated to a transition temperature, wherein the mixing and heating bond the thermosetting polymeric binder to the metallic effect pigment particles.

Aspect 17 is a powder coating composition of Aspect 16, wherein the metallic effect pigment particles comprise 0.5 weight % to 20 weight % relative to the total solids weight of the powder coating mixture.

Aspect 18 is a powder coating composition of either of Aspects 16 or 17, wherein the thermosetting polymeric binder comprises epoxy resins, polyester resins, polyurethane resins, epoxy/polyester hybrid resins, acrylic resins, fluoropolymer resins, and/or combinations thereof.

Aspect 19 is a powder coating composition of any one of Aspects 16 through 18, wherein the polymeric binder comprises a crosslinking agent and/or curing catalyst.

Aspect 20 is a powder coating composition of any one of Aspects 16 through 19, wherein the metallic effect pigment particles comprise aluminum, mica, aluminum oxide, or stainless steel, and/or combinations thereof.

Aspect 21 is a powder coating composition of any one of aspects 16 through 19 that is produced by a method of any one of Aspects 1 through 15.

Aspect 22 is a method for producing a powder coating mixture comprising: receiving metallic effect pigment particles and powder particles, the powder particles including a thermosetting polymeric binder; mixing the metallic effect pigment particles with the powder coating particles, the mixing comprising imparting acoustic energy to the effect pigment particles and the powder coating particles, whereas the acoustic energy heats the metallic effect pigment particles and the powder coating particles by a frictional interaction between the metallic effect pigment particles and the powder coating particles; heating the metallic effect pigment particles and the powder coating particles to a transition temperature, the transition temperature being at or near a transitional temperature of the thermosetting polymeric binder; bonding the metallic effect pigment particles to at least the thermosetting polymeric binder during the heating; and cooling the bonded metallic effect pigment particles and powder particles to form a powder particle mixture.

Aspect 23 is a powder coating composition of any one of aspects 16 through 19 that is produced by a method of any Aspect 22.

Aspect 24 is a is a method for producing a powder coating mixture of Aspect 22 that includes any of the features of the method for producing a powder coating mixture of Aspects 1 through 15.

The invention claimed is:

1. A method for producing a powder coating mixture comprising:
receiving effect pigment particles and powder coating particles;
mixing the effect pigment particles with the powder coating particles, the mixing comprising imparting acoustic energy to the effect pigment particles and the powder coating particles;
heating the effect pigment particles and the powder coating particles, the heating bonding the effect pigment particles to the powder coating particles; and
cooling the bonded effect pigment particles and the powder coating particles.

2. The method of claim 1, wherein the effect pigment particles and the powder coating particles are mixed without the use of high shear forces.

3. (canceled)

4. The method of claim 1, wherein the effect pigment particles and the powder coating particles are mixed in a continuous process.

5. The method of claim 1, wherein the received pigment particles comprise agglomerations of the effect pigment particles, and the acoustical energy imparted to the effect pigment particles de-agglomerates the agglomerated effect pigment particles.

6. The method of claim 5, wherein the de-agglomeration of the effect pigment particles occurs without damaging a structure of the effect pigment particles.

7. The method of claim 5, wherein the de-agglomeration of the effect pigment particles occurs without damaging an external surface of the effect pigment particles.

8. The method of claim 1, wherein the heating comprises the use of heat generated internally from friction due to the acoustic energy.

9. The method of claim 8, wherein heating further comprises the use of heat generated from an external source.

10. The method of claim 1, wherein the heating step occurs in conjunction with the mixing step.

11. The method of claim 1, wherein the heating step, the mixing step, and the cooling step each occur in conjunction.

12. The method of claim 1, wherein the heating occurs for an amount of time to cause the powder particles to become tacky, and the tacky powder particles bond with the effect pigment particles.

13. The method of claim 12, wherein the cooling begins once the powder particles become tacky.

14. The method of claim 1, wherein the heating comprises heating the mixture to a temperature near to, or greater than, the Tg of the powder particles.

15. The method of claim 1, wherein the acoustic energy comprises an amplitude range of at least 0.02 inches to 0.5 inches and a frequency of 5 hertz to 150 hertz.

16. A powder coating composition comprising a thermosetting polymeric binder and metallic effect pigment particles, the thermosetting polymeric binder and metallic effect pigment particles mixed with acoustic energy and heated to a transition temperature, wherein the mixing and heating bond the thermosetting polymeric binder to the metallic effect pigment particles.

17. The powder coating composition of claim 16, wherein the metallic effect pigment particles comprise 0.5 weight % to 20 weight % relative to the total solids weight of the powder coating composition.

18. The powder coating composition of claim 16, wherein the thermosetting polymeric binder comprises epoxy resins, polyester resins, polyurethane resins, epoxy/polyester hybrid resins, acrylic resins, fluoropolymer resins, and/or combinations thereof.

19. The powder coating composition of claim 16, wherein the polymeric binder comprises a crosslinking agent and/or curing catalyst.

20. The powder coating composition of claim 16, wherein the metallic effect pigment particles comprise aluminum, mica, aluminum oxide, or stainless steel, and/or combinations thereof.

21. A method for producing a powder coating mixture comprising:
receiving metallic effect pigment particles and powder particles, the powder particles including a thermosetting polymeric binder;
mixing the metallic effect pigment particles with the powder coating particles, the mixing comprising imparting acoustic energy to the effect pigment particles and the powder coating particles, whereas the acoustic energy heats the metallic effect pigment particles and the powder coating particles by a frictional interaction between the metallic effect pigment particles and the powder coating particles;
heating the metallic effect pigment particles and the powder coating particles to a transition temperature, the transition temperature being at or near a transitional temperature of the thermosetting polymeric binder;
bonding the metallic effect pigment particles to at least the thermosetting polymeric binder during the heating; and
cooling the bonded metallic effect pigment particles and powder particles to form a powder particle mixture.
